(19) United States
(12) Patent Application Publication
(10) Pub. No.: US 2009/0157222 A1
(43) Pub. Date: Jun. 18, 2009

(54) NETWORK-BASED ROBOT SYSTEM AND METHOD FOR PERFORMING CONTENT TRANSMISSION/EXECUTION THEREIN

(75) Inventors: Seung-Woog Jung, Daejeon (KR); Kyeong Ho Lee, Daejeon (KR); Joong Bae Kim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/336,110

(22) Filed: Dec. 16, 2008

(30) Foreign Application Priority Data
Dec. 17, 2007 (KR) 10-2007-0132860

(51) Int. Cl. G06F 19/00

(52) U.S. Cl. 700/245

(57) ABSTRACT

A network-based robot system for performing content transmission/execution includes a content management unit for managing contents created in a tree-like, hierarchical structure, and one or more robots connected to the content management unit over a network. Each robot requests the content management unit to provide a content to be executed by the robot, downloads the content from the content management unit via the network, and determines a content execution plan to execute the content depending on specification of the robot.

### CROSS-REFERENCE(S) TO RELATED APPLICATION(S)

The present invention claims priority of Korean Patent Application No. 10-2007-0132860, filed on Dec. 17, 2007, which is incorporated herein by reference.

### FIELD OF THE INVENTION

The present invention relates to a network-based robot system, and more specifically, to a network-based robot system and a method for performing content transmission/execution in the network-based robot system suitable for adaptively transmitting and executing contents depending on the performance of a robot or the specification of devices equipped in the robot.

This work was supported by the IT R&D program of MIC/IITA [2005-S-033-03, Embedded Component Technology and Standardization for URC].

### BACKGROUND OF THE INVENTION

High-price multifunctional robots are loaded with various functions, such as video processing, self-locomotion, voice recognition/synthesis, motor and sensor control, content execution, and so on, such that a wide range of hardware and software from a simple hardware controlling a motor or a sensor to high-spec hardware and software processing high functions is executed inside the robots. Such expensive multifunctional robots have a sufficiently large internal memory capacity, and therefore, all desired contents can be stored within the robots and executed.

On the other hand, inexpensive toy robots or service robots for training have poor hardware specifications and thus cannot offer any of high functions but simply provide fixed, given functions. In other words, it is difficult to add new functions or new contents to these robots.

To complement those shortcomings, a variety of service robots using network has appeared. That is, various contents to be executed by the service robots are stored in an external server, so that desired contents are downloaded and executed whenever required. These schemes make it easier to add new contents and update old contents.

Such content execution systems in the robots are largely divided into two types. The first type of content execution systems are designed specifically for high-price multifunctional robots with a large internal memory capacity, and thus, all contents are downloaded at once and executed. The second type of content execution systems are designed specifically for low-price robots with relatively poor hardware specifications and a poor memory capacity, so contents are not downloaded but executed in streaming format.

There are service robots recently issued as a compromise between high-price robots and low-price robots, which have hardware specifications somewhat less than those of high-price robots but better than those of low-price robots, and are trying to offer a variety of content services. However, the existing content providing schemes cannot offer a content execution system based on robot hardware specifications of various types of robots.

In general, basic contents that are executed by a robot include audio contents presented through a speaker in form of sound or music, video contents composed of still images and/or moving pictures, multimedia contents such as animation with pictures or flash being exhibited on a display that is installed at the robot, robot motion contents for making the motion of the robot (arms, neck, legs, etc.), device contents for outputting colors through LCD buttons installed at the robot, etc. In general, contents were created one by one and stored in the robot for execution, or contents were transferred in streaming format and then executed in real time.

### SUMMARY OF THE INVENTION

It is, therefore, an object of the present invention to provide a network-based robot system and a method for performing content transmission/execution in the network-based robot system suitable for adaptively transmitting and executing contents depending on the performance of a robot or the specification of devices equipped in the robot.

Another object of the present invention is to provide a network-based robot system and a method for adaptively performing content transmission/execution in the network-based robot system, in which all or only part of the contents are provided and executed depending on the performance of a robot or the specification of devices equipped in the robot. In accordance with an aspect of the present invention, there is provided a content transmission/execution method in a network-based robot system including:

creating, in a content authoring unit, contents to be executed in a plurality of robots;

registering the contents in a content management unit the contents;

transferring, in a particular robot which intends to execute a content among the plurality of robots, its robot profile and an identifier of the content which intends to execute by the particular robot to the content management unit;

searching, in the content management unit, a content corresponding to the content identifier;

interpreting the searched content to obtain attributes on the content, and transferring the attributes of the content to the particular robot;

determining, in the particular robot, a content execution plan based on the attributes of the content and a device profile of devices equipped in the particular robot; and

transferring the content to the particular robot depending on the content execution plan.

In accordance with another aspect of the present invention, there is provided a network-based robot system for performing content transmission/execution, including:

a content creating tool for creating contents in a tree-like, hierarchical structure;

a content management unit for managing the created contents; and

one or more robots, connected to the content management unit over a network, wherein each robot requests the content management unit to provide a content to be executed by the robot, downloads the content from the content management unit via the network, and executes the content in accordance with a content execution plan determined depending on specification of the robot.

### BRIEF DESCRIPTION OF THE DRAWINGS

The above and other objects and features of the present invention will become apparent from the following description of embodiments, given in conjunction with the accompanying drawings, in which:

FIG. 1 shows a schematic view of a network-based robot system in accordance with an embodiment of the present invention;

FIG. 2 illustrates content in extensible markup language (XML) format, which is created by a content creating tool shown in FIG. 1;

FIG. 3 presents a detailed block diagram of the content management unit and the robot shown in FIG. 1; and

FIG. 4 illustrates a flowchart for explaining a content transmission/execution method in a network-based robot system in accordance with an embodiment of the present invention.

### DETAILED DESCRIPTION OF THE EMBODIMENTS

Hereinafter, embodiments of the present invention will be described in detail with reference to the accompanying drawings.

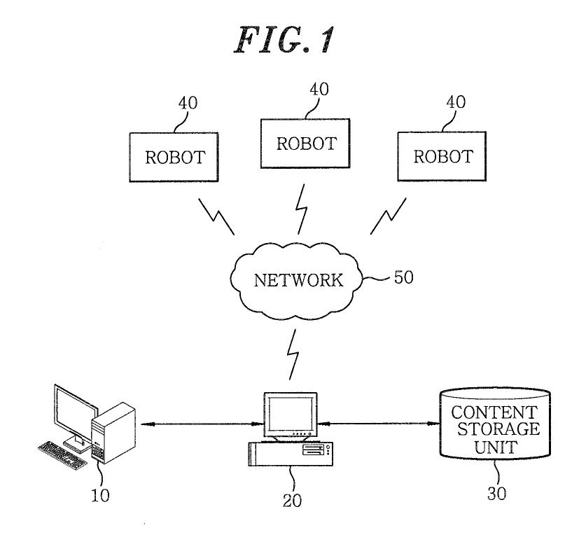

FIG. 1 shows a schematic view of a network-based robot system in accordance with an embodiment of the present invention. The network-based robot system shown in FIG. 1 includes a content creating tool 10, a content management unit 20, a content storage unit 30, a network 50, and a plurality of robots 40.

The content creating tool 10 creates contents to be executed by the robots 40 in a tree-like, hierarchical structure.

The content management unit 20 manages the contents that are created by the content creating tool 10. For example, the content management unit 20 provides functions of managing contents, such as, registering (or storing) the contents in the content storage unit 30, searching and deleting a specific content among the contents registered in the content storage unit 30. The content management unit 20 may be implemented with hardware and software executed on a notebook computer, a laptop computer, a PDA, a desktop computer, or a network-based computer.

The content storage unit 30 stores the contents, provided from the content management unit 20, wherein all the stored contents are managed by the content management unit 20. The content storage unit 30 may be realized by the use of a relational database management system (RDBMS) such as Oracle, Infomix, Sybase, and DB2, or an object oriented database management system (OODBMS) such as Gemston, Orion, and O2 which are adapted to meet the present invention, and also has adequate fields for achieving its own functions.

The plurality of robots 40 are connected to the content management unit 20 over the network 50, e.g., a wireless network. The robots 40 each have basic hardware such as a speaker, a display, and an actuator for executing a content that is transmitted from the content management unit 20 over the network 50, and software for driving and controlling the hardware.

The network 50 may be implemented in diverse systems, and needless to say, a high speed network with less data loss is preferred. Examples of available wireless network 50 include wireless LAN (IEEE 802.11x), wireless USB, Bluetooth, ZigBee, ultra wide bandwidth (UWB), etc.

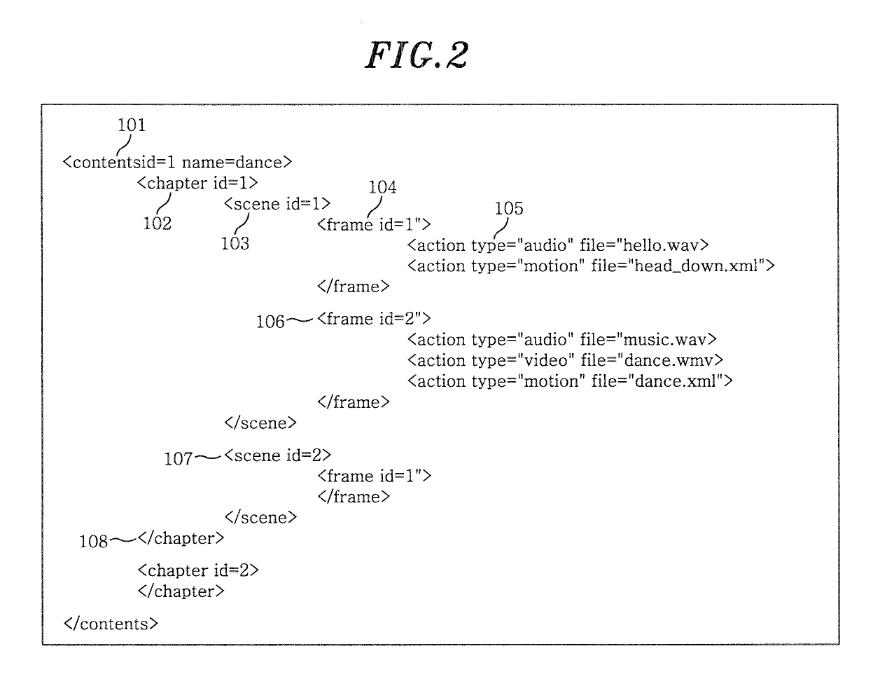

FIG. 2 illustrates content components in extensible markup language (XML) format, in which the content is created by the content creating tool 10 depicted in FIG. 1 in a tree-like, hierarchical structure.

Referring to FIG. 2, the top node in the content tree is a “contents” item 101. The “contents” item 101 is composed of a plurality of “chapter” items 102 and 108, each of which is composed of a plurality of “scene” items 103 and 107. Each of the “scene” items 103 and 107 is composed of a plurality of “frame” items 104 and 106, each of which is composed of a plurality of “action” items 105.

The “contents” item 101, the “chapter” items 102 and 108, the “scene” items 103 and 107, and the “frame” items 104 and 106 each have an identifier “id”.

The “contents” item 101 represents the entire contents, and specifies identification and name of the contents. According to what is specified by the “contents” item 101, the identifier for the content is “1” and the name of the content is “dance”.

Regarding the execution of the “contents” item 101, out of the “chapter” items 102 and 108 included in the “contents” item 101, the “chapter” item 102 in a higher position is executed first, and the other “chapter” item 108 is sequentially executed as soon as the execution of the “chapter” item 102 is completed.

As for the execution order within the “chapter” item 102, out of the “scene” items 103 and 107 included in the “chapter” item 102, the “scene” item 103 in a higher position is executed first, and the other “scene” item 107 is sequentially executed as soon as the execution of the “scene” item 103 is completed.

As for the execution order within the “scene” item 103, out of the “frame” items 104 and 106 included in the “scene” item 103, the “frame” item 104 in a higher position is executed first, and the other “frame” item 106 is executed next after execution of the “frame” item 104 is completed.

As for the execution order within the “frame” item 104, among other “action” items included in the “frame” item 104, the “action” item in the highest position is executed first and then in downward order. The “action” item is composed of “type” that indicates the type of an action, and “file” item that contains actual details of the action.

The “type” of an “action” includes “audio” for sound, “video” for image, and “motion” for motion of a robot, but may include other things like a picture or characters on an LCD installed in the robot.

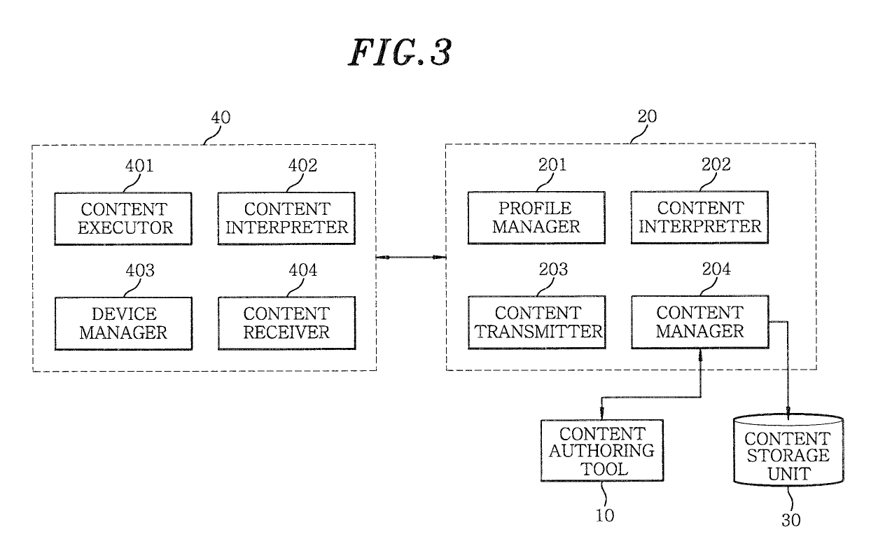

FIG. 3 illustrates a detailed block diagram of the content management unit 20 and one of the robots 40 shown in FIG. 1.

The content management unit 20 includes a profile manager 201 for managing profiles of the robots 40, a content manager 204 for managing contents that are created by the content creating tool 10, for storing the contents in the content storage unit 30 and for searching any of the contents if necessary. The content management unit 20 further includes a content interpreter 202 for interpreting the contents to find out size and structure of the content, and a content transmitter 203 for delivering the contents to the robot 40 via the wireless network 50.

In the meantime, the robot 40 includes a device manager 403 for managing a robot profile and a device profile of all kinds of devices such as a memory and hardware equipped in the robot, a content receiver 404 for receiving the contents that are transferred from the content management unit 20, a content interpreter 402 for interpreting the received contents, and a content executer 401 for executing the interpreted contents.

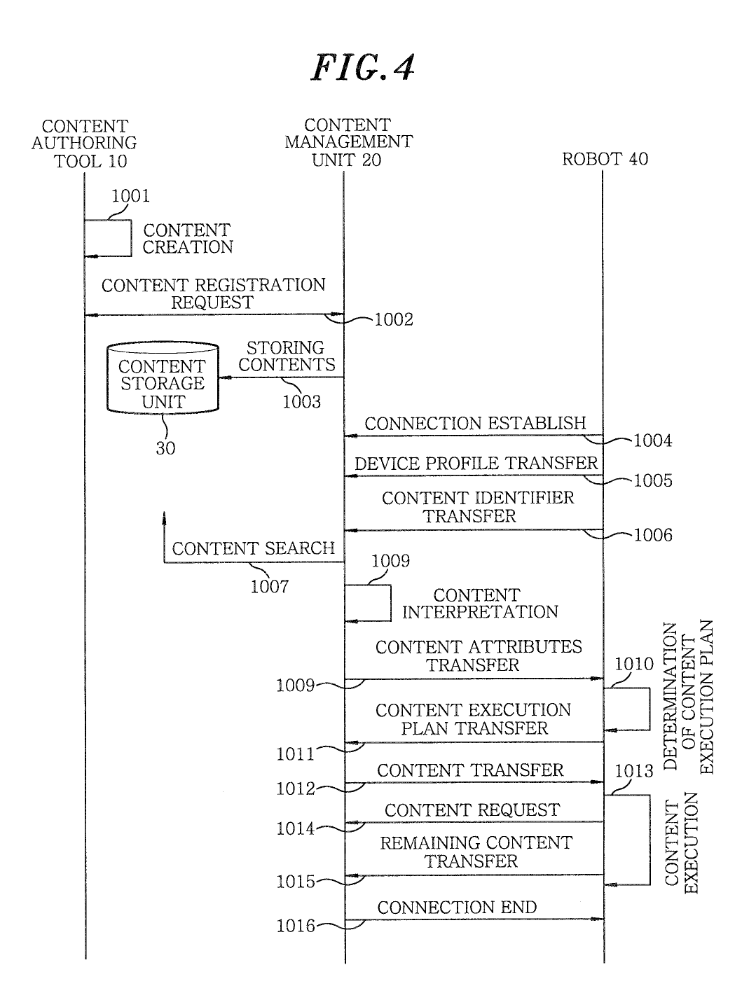

With reference to the configuration discussed above and to the flowchart illustrated in FIG. 4, an explanation will now be made for a content transmission/execution method performed in the network-based robot system in accordance with the present invention.

First, in step 1001, a content developer creates contents in extensible markup language (XML) format using the content creating tool 10. The created contents have a tree-like, hierarchical structure as depicted in FIG. 2.

In step 1002, the content creating tool 10 issues a content registration request to the content management unit 20.

Next, in step 1003, the content management unit 20 stores the content in the content storage unit 30 by the request of the content creating tool 10. Through these steps 1001, 1002, and 1003, the content created by the content creating tool 10 is registered in the content storage unit 30.

Thereafter, in step 1004, the robot 40 establishes a connection to the content management unit 20 via the wireless network 50, and in steps 1005 and 1006, the robot 40 transmits its robot profile and an identifier of content inherently provided therein at the manufacture of the robot or through the purchase of the contents, which the robot 40 intends to execute, to the content management unit 20.

In the present invention, if necessary, the content transmission/execution method further includes authenticating whether the robot is rightful using the robot profile provided from the robot. In this case, the content management unit 20 is configured to receive the content identifier from the robot if it is determined that the robot is identified as a rightful robot.

When the content identifier is provided from the robot 40, in step 1007, the content management unit 20 searches the content storage unit 30 for a content that corresponds to the content identifier.

In step 1008, the content management unit 20 interprets the content that is searched in the content storage unit 30, so as to obtain attributes about the content, such as, content size, structure of the content, size of each content item, and so on. Subsequently, in step 1009, the content management unit 20 transfers the attributes about the content to the robot 40.

After that, in step 1010, the robot 40 determines a content execution plan based on the attributes about the content provided from the content management unit 20 and the device profile thereof.

In a following step 1011, the robot 40 transfers the content execution plan to the content management unit 20, and in step 1012, the content management unit 20 transfers all or part of the content to the robot 40 based on the content execution plan that is transferred from the robot 40.

Then, in step 1013, the robot executes all or part of the content that is transferred from the content management unit 20. When the robot 40 executes the content, if only part of the content is downloaded from the content management unit 20 via the wireless network 50, in step 1014, the robot 40 requests the content management unit 20 to provide the remaining, non-downloaded content while executing the content in step 1013.

Thereafter, in step 1015, the content management unit 20 transfers the remaining content to the robot 40. When the robot 40 has completed execution of all contents, the robot 40 terminates the connection to the content management unit 20.

More specifically, in step 1010 for determining the content execution plan, the robot 40 determines whether it should require to download all the items in the content, i.e., “contents”, “chapter’, “scene”, “frame”, and “action”, or whether it should require to download only a particular “chapter”, or whether it should require to download only a particular “scene” in a particular “chapter”, or whether it should require to download only a particular “frame” in a particular “scene”, or whether it should require to download only a particular “action” in a particular “frame”.

Then, in step 1011, the robot 40 informs the content execution plan of the content management unit 20.

Next, in step 1012, the content management unit 20 transfers only content items that are required by the robot based on the content execution plan to the robot 40.

In succession, in step 1013, the robot 40 executes the content items downloaded via the wireless network 50 from the content management unit 20. When the robot 40 needs to execute non-downloaded content items during execution of the content, in steps 1014 and 1015, the robot 40 requests the content management unit 20 to provide the remaining content items and executes the remaining content items upon receipt thereof.

With the present invention, because item of moving picture files usually has a large size, the robot 40 may require to download all other items except for the “video” item as the “type” for the “action”, and execute them. If there is an item that requires “video”, the robot may acquire the same from the content management unit 20 in streaming format and execute it.

As explained earlier, the present invention implements an adaptive content transmission/execution technique, wherein contents are created in a tree-like, hierarchical structure and all or only part of contents are downloaded to a robot for executing them depending on the performance of the robot or the specification of devices equipped in the robot.

While the invention has been shown and described with respect to the preferred embodiments, it will be understood by those skilled in the art that various changes and modification may be made without departing from the scope of the invention as defined in the following claims.

What is claimed is:

1. A content transmission/execution method in a network-based robot system comprising:
creating, in a content authoring unit, contents to be executed in a plurality of robots;
registering the contents in a content management unit the contents;
transferring, in a particular robot which intends to execute a content among the plurality of robots, its robot profile and an identifier of the content which intends to execute by the particular robot to the content management unit;
searching, in the content management unit, a content corresponding to the content identifier;
interpreting the searched content to obtain attributes on the content, and transferring the attributes of the content to the particular robot;
determining, in the particular robot, a content execution plan based on the attributes of the content and a device profile of devices equipped in the particular robot; and
transferring the content to the particular robot depending on the content execution plan.

2. The method of claim 1, further comprising:
authenticating whether the particular robot is rightful using the robot profile provided from the particular robot; and
receiving the content identifier from the particular robot if the particular robot is identified as a rightful robot.

3. The method of claim 1, wherein the content is in a tree-like, hierarchical structure having a plurality of items.

4. The method of claim 3, wherein the attributes of the content includes at least one of size of the content, structure of the content, and size of each content item.

5. The method of claim 3, wherein determining the content execution plan comprises determining whether the particular robot should require to download all the items in the content based on the device profile of the robot and the attributes of the content.

6. The method of claim 3, wherein determining the content execution plan comprising determining whether the particular robot should require to download only a particular item in the content and then the remaining content when needed, based on the device profile and the content attributes.

7. The method of claim 1, wherein the content is executed in the robot in streaming format.

8. A network-based robot system for performing content transmission/execution, comprising:
a content creating tool for creating contents in a tree-like, hierarchical structure;
a content management unit for managing the created contents; and
one or more robots, connected to the content management unit over a network, wherein each robot requests the content management unit to provide a content to be executed by the robot, downloads the content from the content management unit via the network, and executes the content in accordance with a content execution plan determined depending on specification of the robot.

9. The network-based robot system of claim 8, wherein the content management unit includes:
a profile manager for managing profiles of the robots;
a content storage unit for storing the contents created by the content creating tool;
a content manager for managing the contents in the content storage unit and searching the content storage unit for a content which a particular robot intends to execute; and
a content transmitter for transmitting the searched content to the particular robot.

10. The network-based robot system of claim 8, wherein the particular robot transfers profile information identifying specification of the particular robot to the content management unit, and requests a content, to be executed by the particular robot, among the contents stored in the content management unit.

11. The network-based robot system of claim 8, wherein the content management unit further comprises a content interpreter for interpreting the content to be executed by the particular robot to find out attributes of the content, the attributes being transferred to the particular robot.

12. The network-based robot system of claim 11, wherein the particular robot, upon receipt of the attributes of the content, determines the content execution plan based on profiles of devices equipped in the particular robot and the attributes of the content.

13. The network-based robot system of claim 9, wherein the particular robot comprises:
a device manager for managing the profiles of devices equipped in the robot;
a content receiver for receiving the content transferred from the content management unit;
a content interpreter for interpreting the content received from the content receiver; and
a content executor for executing the content interpreted by the content interpreter.

14. The network-based robot system of claim 8, wherein the content in a tree-like, hierarchical structure includes a content item, a chapter item, a scene item, and a frame item arranged in sequence,
the content item being composed of a plurality of chapter items, each of which is composed of a plurality of scene items, and each of the plurality of scene items being composed of a plurality frame items, each of which is composed of a plurality of action items.

15. The network-based robot system of claim 14, wherein the content item is a top node of the tree-like, hierarchical structure.

16. The network-based robot system of claim 12, wherein the content execution plan includes a method on whether the particular robot should require downloading all the items in the content based on the device profile of the robot and the attributes of the content.

17. The network-based robot system of claim 12, wherein the content execution plan includes a method on whether the particular should require downloading only a particular item in the content and then the remaining content items when needed, based on the device profile and the attributes of the content.

18. The network-based robot system of claim 12, wherein the content is executed in the particular robot in streaming format.

19. The network-based robot system of claim 8, wherein the network is a wireless network.
